(19) United States
(12) Patent Application Publication
(10) Pub. No.: US 2016/0135597 A1
(43) Pub. Date: May 19, 2016

(54) WHITE BOARD PANEL AND MANUFACTURING METHOD

(71) Applicant: W.A. Krapf, Inc., Macedon, NY (US)

(72) Inventors: Christian Q. Krapf, Rochester, NY (US); John Deats, Brockport, NY (US)

(21) Appl. No.: 14/942,268

(22) Filed: Nov. 16, 2015

Related U.S. Application Data
(60) Provisional application No. 62/079,818, filed on Nov. 14, 2014.

(51) Int. Cl. A47B 97/00; B43L 1/00

(52) U.S. Cl. CPC A47B 97/001; B43L 1/00

(57) ABSTRACT

A display panel includes a single planar section of steel having a front side and an opposing rear side, in which folded edge sections are formed on each lateral side of the steel section and the front side having a dry-erasable surface over at least a portion thereof. At least one double-sided adhesive strip for securing the display panel directly to a supporting surface is disposed on the rear side of the steel section. Additionally, a related method of manufacturing a display panel is also described.

### CROSS REFERENCE TO RELATED APPLICATIONS

This application claims priority under relevant portions of 35 U.S.C. §119 to U.S. Patent Application No. 62/079,818, filed Nov. 14, 2014 and entitled: White Board Panel and Manufacturing Method. The entire contents of this referenced application is herein incorporated by reference.

### TECHNICAL FIELD

The application generally relates to the field of display boards and display board systems. More specifically, the application is directed to an improved display panel and a related method for attaching at least one improved display panel having a dry-erasable surface to a supporting surface, such as a wall or cubicle.

### BACKGROUND

Dry erasable display boards (also colloquially referred to as “whiteboards” “white boards” or “grease boards”) are very well known for purposes of display as commonly found in classrooms, industrial sites, conference rooms and other locales for purposes of calendaring, organizing and announcing events and/or activities, as well as a myriad of other varied uses and/or applications. Dry-erasable display boards are analogous to chalk boards and permit the use of non-permanent marker pens having ink compositions that permit removal from a coated surface using a cloth or eraser. Various types of whiteboards have been created. For example and according to one version, a melamine coating can be provided on a substrate. According to another version, a painted steel or aluminum, use of hard coated magnetic laminates, porcelain applied to steel using a kiln or other heat baked process and PET on steel. An example of a typical ink composition for this purpose is described in U.S. Pat. No. 6,031,023. Dry-erasable display boards can include a porcelain or other suitably coated steel facing surface that enables the use of non-permanent dry marker pens therewith. Due to the steel surface, these display boards further permit the adherence of magnets thereon as well as other labels or other indicators. In addition, the steel surface of a display board can further include at least one grid or other pattern to provide charting, calendaring or other aids for user(s) of the display board, depending on the field or specific application.

An exemplary version of a known whiteboard panel (hereinafter also referred to as a “display board” or “display panel”) is depicted in FIG. 1. The display panel 20 is defined by a thin planar steel section 24 having a dry-erasable porcelain or other coating that has been applied onto a front facing side 26. At least one supporting substrate 28 is sandwiched between a rear surface of the planar steel section 24 and a backing plate 36, such as an aluminum sheet. According to this version, the supporting substrate 28 can be a corrugated cardboard or a similar type of filler material, such as styrofoam, that is disposed over the entire area of the panel 20 with the exception of a center or intermediate region 33 in which a section of a structural material, such as particle board 34, is introduced. An edge portion 38 of the planar steel section 24 extends across the intermediately disposed supporting substrate 28 and is folded over a corresponding lateral edge of the backing plate 36. The particle board 34, according to this known version, includes a recessed angled slot or cleat 37 that extends along substantially the entire width of the display panel 20 to enable mounting of same to a wall or other supporting surface (not shown in this view). The backing plate 36 also includes a slot 41 to enable access to the recessed angled slot 37 for purposes of mounting the board 20 to a supporting surface (not shown) based on alignment of the formed cleat 37 to a supporting fastener(s) (not shown).

There is a general need in the field to simplify and improve the manufacturability of such display panels or display boards, as well as a further general need to provide additional flexibility and versatility to the use of display panels and display systems.

### BRIEF DESCRIPTION

Therefore and in accordance with one aspect, there is provide a dry-erasable display panel comprising a single planar steel section having a front facing surface and an opposing rear facing surface. Marginal edge sections are formed on each lateral side of the steel section, the marginal edge sections being initially bent transverse to the plane of the steel section and then inwardly directed toward an opposing edge of the panel. At least one adhesive strip is directly provided on the rear facing surface of the planar steel section to permit adherence of the display panel to a supporting surface, such as a wall or cubicle.

In accordance with another aspect, there is described a method of manufacturing a dry-erasable display panel, the method comprising the steps of:

a) providing a planar steel section having a front facing surface and an opposing rear facing surface, the front facing surface having a dry-erasable coating applied thereto;

b) cutting each corner of the planar steel section;

c) bending two opposing lateral edges of the steel section transverse to the plane of the steel section;

d) bending the two opposing lateral edges inwardly toward each other and creating opposing side edge sections; and

e) bending the remaining lateral edges of the steel section transverse to the plane of the steel section and inwardly toward one another to form upper and lower edge sections.

In a preferred version, at least one adhesive strip is attached to the rear facing surface of the display panel, enabling the display panel to be attached to a supporting surface, such as a wall or a cubicle.

One advantage realized is a simplified technique for manufacturing a display board or panel that is lightweight and provides adequate structural integrity when mounted to a suitable supporting surface.

Another advantage realized is that of increased versatility and functionality for display panels and display systems.

Yet another advantage is that of overall savings in terms of cost and material in the manufacture of the herein described display panels with a simplified yet reliable structure.

Still another advantage is that a plurality of display panels, as described herein, can be seamlessly supported in combination on a supporting surface, such as a wall.

These and other features and advantages will become apparent to one of sufficient skill upon reading the following Detailed Description, which should be read in conjunction with the accompanying drawings.

### BRIEF DESCRIPTION OF THE DRAWINGS

FIG. 1 is a rear perspective view, partially in section, of a known dry-erasable display panel; and

FIGS. 2(a)-2(h) depict various rear assembly views of a display panel in sequence, illustrating the manufacture thereof, the display panel being manufactured in accordance with an exemplary embodiment.

### DETAILED DESCRIPTION

The following description is specifically directed to a dry-erasable (also referred to throughout this discussion as “whiteboard”) display panel, as well as a related method of manufacture of an improved display panel. Though a single exemplary embodiment is described herein, it will be readily apparent that other variations and modifications will be readily apparent to one of sufficient skill. In addition and throughout the course of discussion, a number of terms are used in order to provide a suitable frame of reference with regard to the accompanying drawings. However, these terms, which may include “front”, “rear”, “upper”, “lower”, “vertical”, “horizontal” “top”, “bottom” and the like however, are not intended to be limiting of the herein described inventive concepts which are discussed herein, unless so specifically indicated. In addition, the drawings are also intended to clearly illustrate the salient features of the exemplary display panel. To that end, the reader should not rely upon the drawings for purposes of sizing or scaling of any specific aspect.

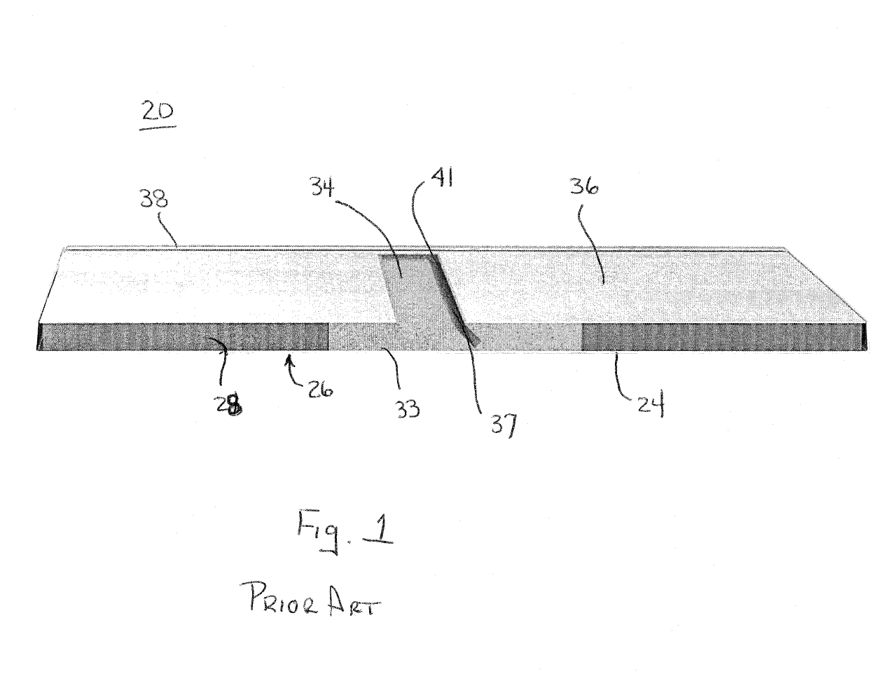

One prior means for manufacturing and attaching a display panel is described in co-pending U.S. patent application Ser. No. 14/043,441, incorporated by reference in its entirety herein. This patent describes a hanger system for display boards, that includes the display board 20 shown according to FIG. 1. As discussed previously, this display board 20 is defined by a plurality of layers including a front facing steel panel 24, a back panel or sheet 36 and an intermediate substrate layer 28. An angled slot or cleat 37 is formed over the width dimension along an intermediate supporting portion 33 of the display board 20. The supporting portion 33 is made from a supporting material, such as particle board, in which the formed cleat 37 and slot 41 is sized to permit engagement with a support bar (not shown) that is fixedly attached to a supporting surface (not shown), the support bar having a series of spaced engagement portions. The engagement portions permit a plurality of display boards 20 to be attached in a plurality of different configurations to supporting surfaces, thereby defining walls or cubicles, depending on the application.

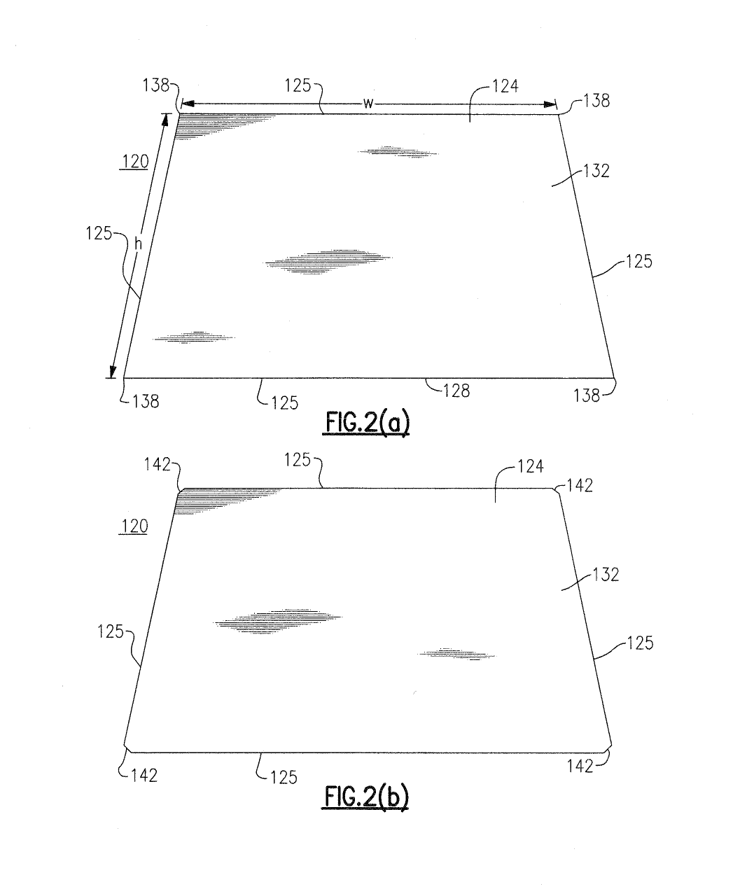

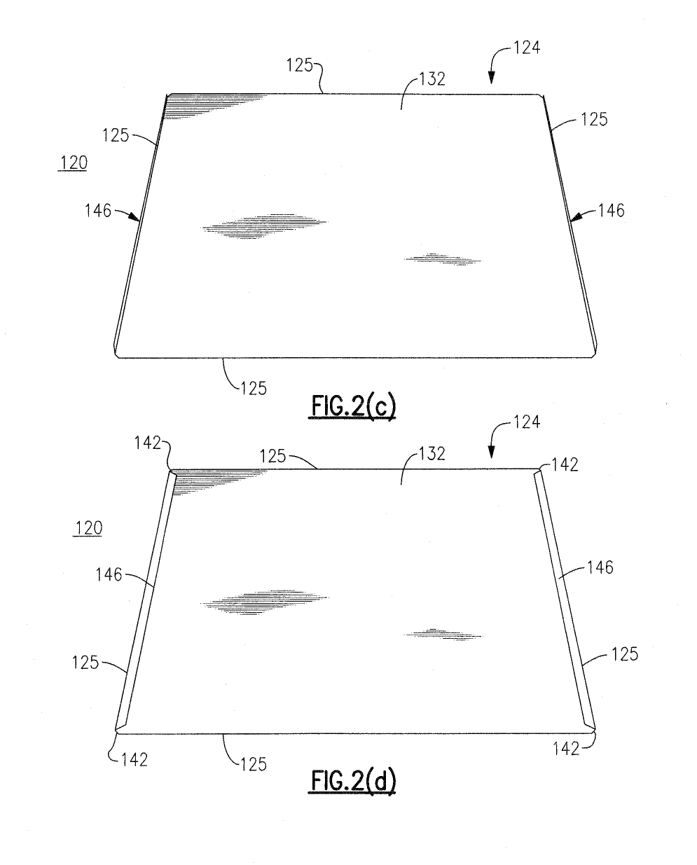

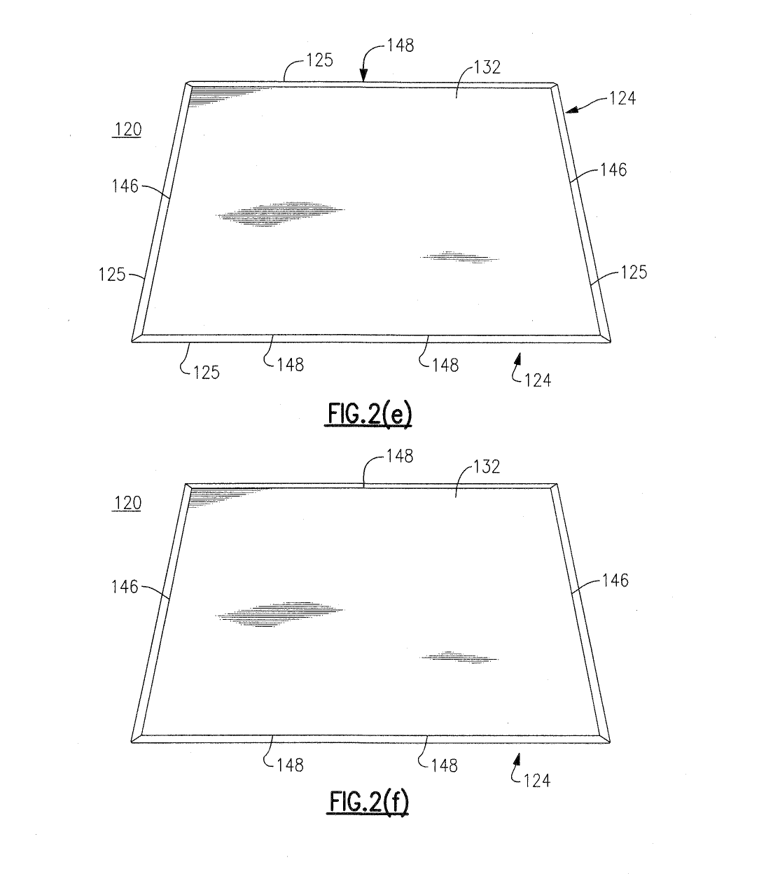

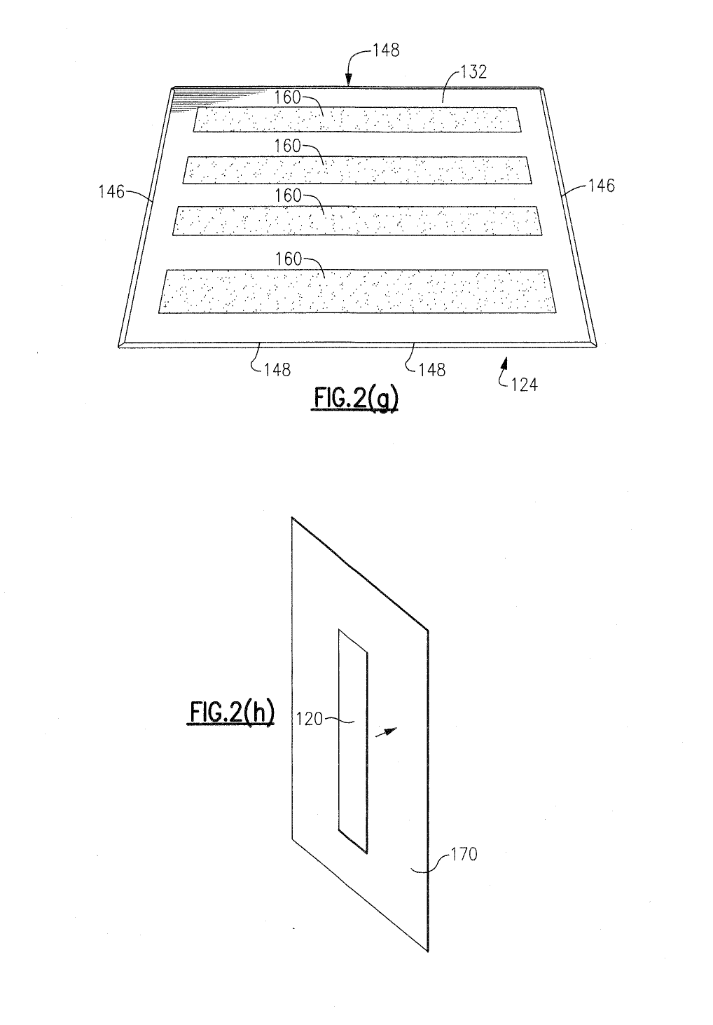

Referring to FIGS. 2(a)-2(h), a number of views are provided in sequence of a display panel 120 made in accordance with an exemplary embodiment, each being viewed from a rear perspective thereof with the exception of FIG. 2(h), which provides a front perspective view. These drawings detail the various incremental steps taken from an initial pre-assembled condition to a fully assembled display panel 120. When assembled, the display panel 120 is configured for attachment to a wall, cubicle or other suitable supporting surface, whether alone or in combination with any varied number of display panels, as discussed herein.

Referring to FIG. 2(a), a single thin planar section of steel 124 is defined by a front facing surface or side 128 and an opposing rear facing surface or side 132, the steel section being cut to an appropriate size. According to this exemplary embodiment, the steel section 124 is defined by a rectangular configuration having a length dimension of approximately 36 inches and a width dimension of approximately 24 inches and in which the thickness of the herein described steel section 124 is between approximately 12 inches and 96 inches. Based on this rectangular construction, the planar steel section 124 is defined by four (4) bordering lateral sides 125. It will be readily apparent, that the foregoing configuration, as well as the size of the steel section 124 is merely exemplary and can easily assume a myriad of suitable shapes and sizes, provided that the steel section 124 is planar.

The front facing side 128 of the steel section 124 is initially treated, according to this exemplary embodiment, to create a dry-erasable surface. According to one version, a porcelain surface is applied by baking or other suitable process. An example of a dry-erasable surface as described is applied to display panels marketed under the tradename of Whitewall, commercially marketed by W.A. Krapf, Inc. It should be noted, however, that the exact constituency and application method of the dry-erasable surface is not critical to the workings of the present invention. That is, several different processes are widely known in the field of display board systems for creating dry-erasable surfaces. Exemplary application methods are described in WO 2009/002814A1 and US Patent Application Publication No. 2004/0110032, each of these documents being entirely incorporated by reference herein. In addition and though the present embodiment relates to entirely covering the front facing side 128 with a dry-erasable coating, the steel section 124 can alternatively include a front facing side in which only a portion(s) includes a dry-erasable coating, enabling the front facing side 128 of the planar steel section 124 to be additionally used for other purposes.

Referring to FIG. 2(b), each of the respective corners 138 of the formed planar steel section 124 are machined using a sheer or other suitable apparatus. As shown and following this portion of the manufacturing process, each of the corners 138 of the planar steel section 124 are replaced with angled (e.g., 45) degree cuts 142.

Referring to FIG. 2(c) and according to this exemplary embodiment, two opposing marginal side edges 125 of the planar steel section 124 are then bent or folded approximately 90 degrees (using a break), thereby defining respective first edge sections 146, each extending transverse relative to the remainder of the planar steel section 124. As defined herein, the marginal edge sections 146 extend outwardly from the rear facing side 132 of the planar steel section 124 and away from the front facing side 124. The first edge sections 146, referring to FIG. 2(d), are then bent inwardly toward the opposing side of the panel 120 and engaged against the rear surface 132, thereby forming a flattened hem bend, such as shown in FIG. 2(e). The width of each side edge according to this specific embodiment is approximately 7 mm.

Referring to FIG. 2(f), each of the foregoing assembly steps 2(c), 2(d) and 2(e) are then repeated for the two remaining opposed lateral edges of the planar steel section 124 by creating opposing edge sections 148 that are similar in configuration to the first edge sections 146, which are subsequently bent inwardly toward the front facing surface, thereby defining a total of four (4) flattened hem bends that cover each lateral edge of the rear surface 132 of the panel 124. It should be noted that the particular order of bending (i.e., whether the first or second edge sections 146, 148) is completely arbitrary.

Referring to FIG. 2(g) and according to this exemplary embodiment, a plurality of double-sided adhesive strips 160 are applied to the rear facing side 132 of the display panel 124. According to this specific embodiment, a total of four (4) double-sided adhesive strips 160 are applied in parallel and spaced relation with one another, but it will be readily apparent that the number of adhesive strips and application orientation can be easily varied based on the adhesives used, as well as other characteristics. For example, a single adhesive strip (not shown) that encompasses the entire rear side of the display panel could be used. Alternatively, at least one magnet (not shown) can be used in lieu of or in combination with the double-sided adhesive strips 160.

Finally and as shown in FIG. 2(h), the assembled display panel 120 can be attached to a suitable supporting surface 170, such as a wall, by removing the paper backing of each of the adhesive strips 160 and securing the rear facing side 132 of the assembled panel to the supporting surface 170 under pressure. For purposes of the present invention, a plurality of dry-erasable panels (not shown), each made in accordance with the foregoing description, can be combined to form a series of display panels and/or a single composite display panel (not shown) by aligning the edges of respectively mounted display panels together or alternatively, a single display panel having suitable dimensions can be provided wherein the flattened hem bends enable mounting to occur almost seamlessly and in which the display panels 120 can be situated closely to one another to form the composite display panel, which can be appropriately sized based on the application or use intended.

### PARTS LIST FOR FIGS. 1-2(h)

20 board, display
24 steel section, planar thin
26 front facing side
28 supporting substrate
33 center or intermediate section
34 particle board
36 backing plate
37 slot or cleat
38 extending edge portion
41 slot
120 panel, display
124 single thin planar steel section
125 lateral sides
128 front surface, display panel
132 rear surface, display panel
138 corners, section
142 corner cuts
146 first edge sections
148 second edge sections
160 adhesive strips
170 supporting surface

Though a single exemplary embodiment has been described herein, it will be readily apparent that numerous modifications and variations are possible within the intended scope of the invention and concepts that are discussed herein, including the following claims.

1. A display panel comprising:
a single planar steel section having a front side provided at least partially with a dry-erasable coating to permit non permanent marking thereon and an opposing rear side, the steel section having a plurality of lateral edges, each lateral edge being folded inwardly toward the front side of the steel section; and
at least one double-sided adhesive strip attached to the rear side of the planar steel section for securing the display panel directly to a supporting surface.

2. The display panel as recited in claim 1, in which the single planar section is defined by a polygonal configuration and in which each of the corners of the section are removed.

3. The display panel as recited in claim 2, wherein the single planar steel section is defined by a rectangular configuration.

4. The display panel as recited in claim 1, including a plurality of adhesive strips disposed in parallel relation on the rear side of the steel section.

5. The display panel as recited in claim 1, in which each folded edge section is a flattened hem section.

6. A method of manufacturing a dry-erasable display panel, the method comprising the steps of:
a) providing a thin planar steel section;
b) applying a dry-erasable coating on one side of the steel section;
c) cutting each corner of the planar steel section;
d) bending two opposing sides transverse to the plane of the steel section;
e) bending the two opposing sides inwardly toward each other and creating opposing side edge sections; and
f) bending the remaining sides of the panel transverse to the plane of the steel section and inwardly toward one another to form upper and lower edge sections.

7. The method as recited in claim 6, further comprising attaching at least one double sided adhesive strip to the rear side of the planar steel section.

8. The method as recited in claim 7, further comprising attaching the panel to a supporting surface.

9. A method as recited in claim 6, wherein the dry-erasable surface applying step is performed prior to the cutting and bending steps.
